(19) United States
(12) Patent Application Publication
(10) Pub. No.: US 2010/0064901 A1
(43) Pub. Date: Mar. 18, 2010

(54) ROTATING INDUCTION FOOD WARMING DEVICE

(75) Inventors: Brian L. Clothier, Wichita, KS (US); Amil J. Ablah, Wichita, KS (US)

Correspondence Address: HOVEY WILLIAMS LLP, 10801 Mastin Blvd., Suite 1000, Overland Park, KS, 66210, US

(73) Assignee: Thermal Solutions, Inc., Wichta, KS (US)

(21) Appl. No.: 12/558,667

(22) Filed: Sep. 14, 2009

Related U.S. Application Data
(60) Provisional application No. 61/192,013, filed on Sep. 15, 2008.

(51) Int. Cl. A47J 27/00; H05B 6/12

(52) U.S. Cl. 99/331; 219/621; 220/573.1

(57) ABSTRACT

Improved induction heating systems are provided for the cooking/heating of food products requiring stirring during preparation thereof, such as chilis or stews. The stems include an induction heating device (38) and an associated container-holding apparatus (32) having a cradle (52) operable to hold a food container (40) and allow shifting thereof between an upper loading/unloading positions and a lower cooking position. A drive mechanism (36) is provided for rotating the container (40) during induction heating thereof. The apparatus (30) and container (40) can be moved separately from the heating device (38), as required. The container (40) includes a plurality of circumferentially spaced apart temperature sensing assemblies (128) serving to wirelessly transmit temperature information to the heating device (38), in order to control the heating/cooking process. Each assembly (128) preferably includes a temperature sensor (130, 136, 138, 142, 146) operably engaging the container (40), along with a coupled RFID tag (134). The heating device (38) includes an antenna (102) located to interrogate the respective assemblies (128) during rotation of container (40), thereby receiving continuously updated temperature information.

### CROSS-REFERENCE TO RELATED APPLICATION

This application claims the benefit of application Ser. No. 61/192,013, filed Sep. 15, 2008. This prior application is incorporated by reference herein in its entirety.

### BACKGROUND OF THE INVENTION

1. Field of the Invention

The present invention is broadly concerned with improved induction heating systems for use in heating or cooking of food products. More particularly, the invention is concerned with such systems, as well as corresponding methods, wherein the systems include heating apparatus with a base adapted for positioning adjacent an induction heating device, and having structure for receiving a cooking container and a drive mechanism to rotate the container during heating. Advantageously, the base and cooking container are separable from the heating device, and the container is equipped with a plurality of temperature sensing assemblies in order to provide continuous temperature information to the induction heating device by way of wireless RFID temperature feedback.

2. Description of the Prior Art

In the commercial preparation of many food products, continuous or near-continuous stirring is required during heating and cooking. To give but one example, the preparation of chilis mandates virtually continuous stirring during cooking to avoid burning or sticking of the food product to the pot or container. This in turn requires significant manual labor and consequent cost. Moreover, in large commercial operations, the occurrence of improperly cooked and stirred final products is still prevalent.

Restaurants often prepare a full day's supply of chili during the morning hours. After cooking, portions of the supply must be cooled and later reheated for sale. Thus, a number of separate cooking containers are simultaneously being heated, which multiplies the problems of manual labor and cost. Further, the cooling of cooked products is inefficient, owing to the fact that the products are static within the cooler or chiller. This can lead to food safety problems if the products are not quickly chilled to temperatures inhibiting microbial growth.

Several attempts have been made to create a cooker that can automatically stir food and maintain a desired temperature of a food container. For instance, U.S. Pat. No. 4,173,925 describes a variable tilt rotating pot cooker and mixer for making possible automatic, continuous mixing or tumbling, with or without simultaneous heating, of a plurality of foods or substances. The device consists of an outer non-rotating shell pivoting on a fixed base. Inside the shell is a pot rotated by a motor attached to the bottom of the shell. A cover is secured over the pot to prevent the contents for spilling out. The shell and its pot are tiltable as a unit to various angular positions from vertical to horizontal. Compartments, dividers, ridges, projections or other shapes inside the rotating pot or on the pot wall and/or bottom, serve to separate, move, mix, and tumble the contents when the tilt angle of the pot is other than at the vertical position. The shell contains a suitable heating system for raising the temperature of the pot. The device is provided with an automatic temperature control, motor speed control and automatic time cycle and function indicators. However, the outer rotating shell and fixed base of this unit will not allow an induction heater separate from the vessel and the rotating mechanism, such as a standard induction cooktop, to heat the inner food-contacting pot and maintain its heated area at a desired temperature. Furthermore, this system cannot be easily moved to the freezer so that the contents can be quickly chilled. Finally, there is no teaching of any wireless temperature feedback of the internal vessel temperature during operation.

U.S. Pat. No. 5,512,733 teaches a rotating and inclining induction heated pot for holding ingredients. This system uses an induction heater to heat the rotating pot. Temperature control of the pot is provided by means of a flexible temperature sensor that is contacting the bottom of the pot such that the sensor can maintain contact with the pot bottom. However, when the pot is inclined to near horizontal, the sensor can no longer measure the temperature of the food contacting surface when the food level falls below the center axis of the pot. Inasmuch as the food level should be below the center axis for optimum stirring, the '733 device is deficient. Furthermore, a sensor of the type used in the '733 patent is very likely to either be quickly destroyed owing to forces on the wire, or to lose thermal contact with the pot.

There is accordingly a need in the art for improved food preparation systems which overcome the deficiencies of the prior art by providing apparatus for holding and rotating a cooking container during induction heating and which can be fully separated along with the container from the induction heating device. Preferably, such systems should also have a food container providing accurate temperature monitoring on a continual basis, with wireless transmission of the temperature data to an induction heating device for control purposes.

### SUMMARY OF THE INVENTION

The present invention overcomes the problems outlined above, and provides improved systems for heating and cooking of food products requiring stirring during preparation thereof, such as chilis and stews. Broadly speaking, the systems of the invention include an induction heating device and an apparatus cooperable with the heating device in order to provide continuous rotation and consequent stirring during heating and cooking. The apparatus has a base designed to accommodate the induction heating device, as well as structure operable to receive a cooking container holding food product, and a drive mechanism operable to rotate the container during heating. The apparatus is fully separable from the induction heating device at the conclusion of heating/cooking, and can thus be placed in a cooler with the container in place thereon, thereby allowing rotation and stirring of the container during cool-down.

The preferred bases of the invention include a container-receiving cradle shiftable between an upright food product loading and unloading position, and a lowered cooking position wherein the container engages the drive mechanism and is oriented to receive magnetic induction radiation from the associated induction heating device. A releasable locking mechanism on the base serves to hold the container in the lowered cooking position thereof, thereby facilitating bodily movement of the apparatus and container after the conclusion of heating/cooking.

The preferred container of the invention is in the form of a generally cylindrical container body having a bottom wall and a tubular sidewall, with a plurality of temperature sensing assemblies operably secured to the tubular sidewall in circumferentially spaced apart relationship. Each assembly has a temperature sensor operable to sense the temperature of the food product during heating thereof (either directly or indirectly via container temperature), and temperature data-transmitting structure, preferably in the form of an RFID tag, operably coupled with the temperature sensor in order to wireless transmit sensed temperature information to the induction heating device. Each of the data-transmitting structures operates to successively transmit updated temperature information related to the temperature of the food product during rotation of the container. The individual temperature sensing assemblies are preferably mounted in a collar disposed about the container sidewall.

### BRIEF DESCRIPTION OF THE DRAWINGS

FIG. 1 is a perspective view of the preferred rotating cooking device of the invention, illustrating the lid end thereof,

FIG. 2 is another perspective view of the preferred embodiment, illustrating the base end remote from the lid end of FIG. 1;

FIG. 3 is an exploded perspective view similar to that of FIG. 1, and showing the separability of the induction heating device and the base and container structure;

FIG. 4 is a perspective view of the preferred device, illustrating the container in an upright, loading and unloading position;

FIG. 5 is a plan view of the apparatus illustrated in FIGS. 1 and 2;

FIG. 6 is a side elevational view of the apparatus illustrated in FIGS. 1 and 2;

FIG. 7 is a vertical sectional view taken along the line 7-7 of FIG. 6, and illustrating the internal construction of the food-holding container;

FIG. 8 is an enlarged, fragmentary, exploded view illustrating the orientation of one of the RFID tag temperature sensor assemblies carried by the food-holding container, and the relationship of the assembly to the underlying antenna of the induction heating device;

FIG. 9 is a view similar to that of FIG. 8, but depicting another type of RFID tag/temperature sensor assembly;

FIG. 10 is an enlarged, fragmentary, sectional view illustrating one type of temperature sensor in engagement with the food-holding container;

FIG. 11 is a fragmentary, sectional view further illustrating the orientation of the temperature sensor illustrated in FIG. 10;

FIG. 12 is an enlarged, fragmentary, sectional view illustrating another form of temperature sensor embedded within the tubular sidewall of the food-holding container;

FIG. 13 is an enlarged, fragmentary, sectional view further illustrating the orientation of the sensor of FIG. 12;

FIG. 14 is an enlarged, fragmentary, sectional view illustrating a third type of temperature sensor located within a marginal slot formed in the outer wall of the food-holding container;

FIG. 15 is a fragmentary, sectional view further depicting the orientation of the sensor depicted in FIG. 14;

FIG. 16 is an exploded perspective view of one type of food-holding container in accordance with the invention, illustrating the detachable lid and internal mixing fin structure;

FIG. 17 is an exploded view of the container of FIG. 16, showing the optional external insulative sleeve;

FIG. 18 is an enlarged, fragmentary, sectional view of the container structure depicted in FIGS. 16 and 17;

FIG. 19 is a perspective view of a second embodiment of the invention wherein the container is generally spherical in configuration; and

FIG. 20 is an exploded perspective view of the second embodiment illustrated in FIG. 19.

### DETAILED DESCRIPTION OF THE PREFERRED EMBODIMENT

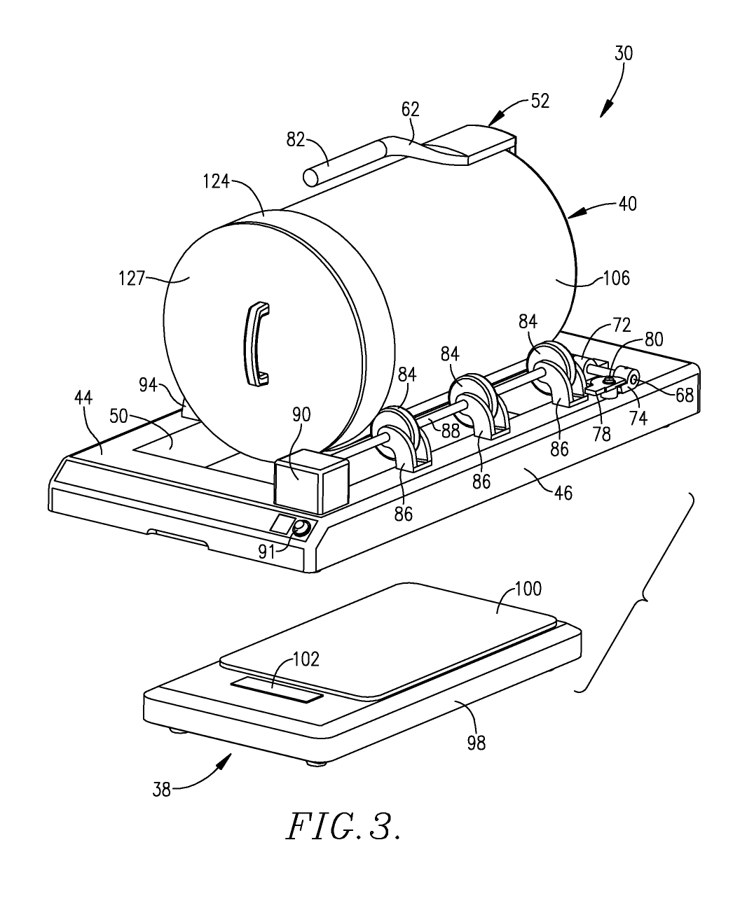

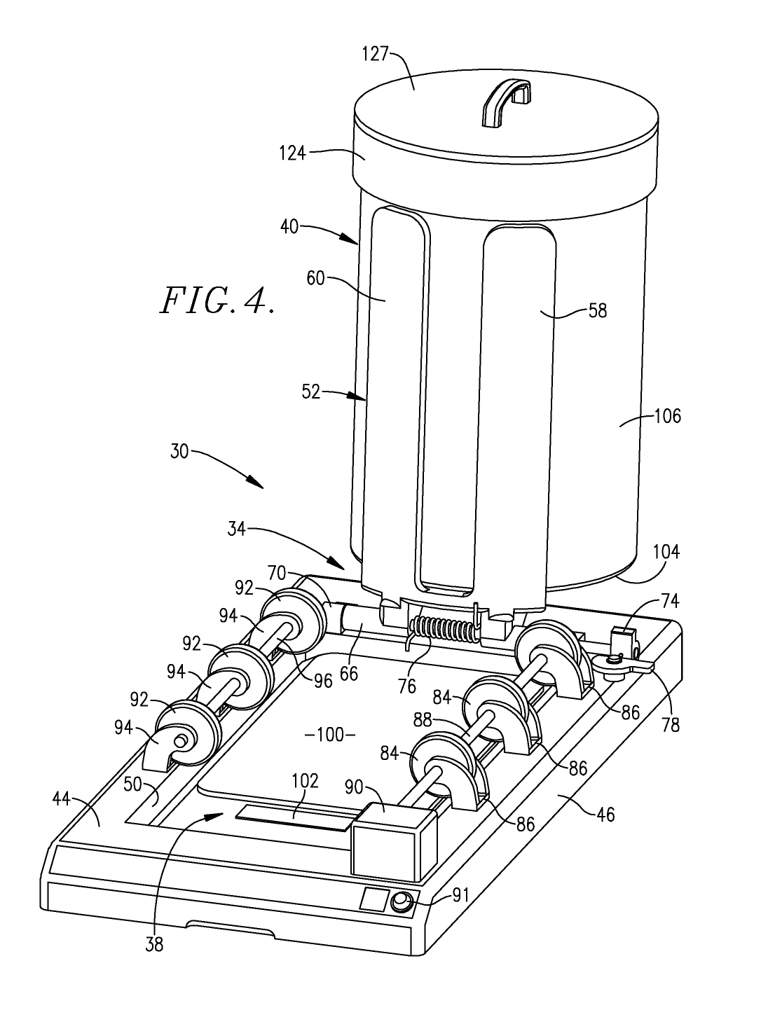

Turning now to the drawings, an apparatus 30 is provided, which is broadly made up of a base 32, with container-receiving structure 34 and drive mechanism 36 mounted on the upper surface of the base. The apparatus 30 is used with a conventional magnetic induction heating device 38 (FIG. 3) that has been equipped with an RFID reader and associated antenna as described in U.S. Pat. No. 6,953,919, which is fully and completely incorporated by reference herein. A container 40 is located within the structure 34 so that the container is selectively movable between an upright product loading and unloading position, depicted in FIG. 4, and a lowered, product cooking position wherein the container 40 engages the drive mechanism 36 in order to rotate the container during operation of device 30 serving to heat the ingredients within the container 40. The overall system made up of apparatus 30 and heating device 38 is particularly suited for food products requiring stirring during preparation thereof, such as chilis or stews. A particular advantage of the invention is the complete separability of apparatus 30, including base 32 and container 40, from the heating device 38.

The base 32 includes a generally rectangular upper wall 44 and depending, circumscribing sidewall structure 46 designed to receive the heating device 38 with the underside of sidewall structure 46 engaging a support surface, such as a table or counter. It will be observed that the base 32 has a large central through-opening 50 making the base 32 fully permeable to the passage of magnetic induction radiation. Additionally, the forward end of the base 32 includes heavy ballast structure 51.

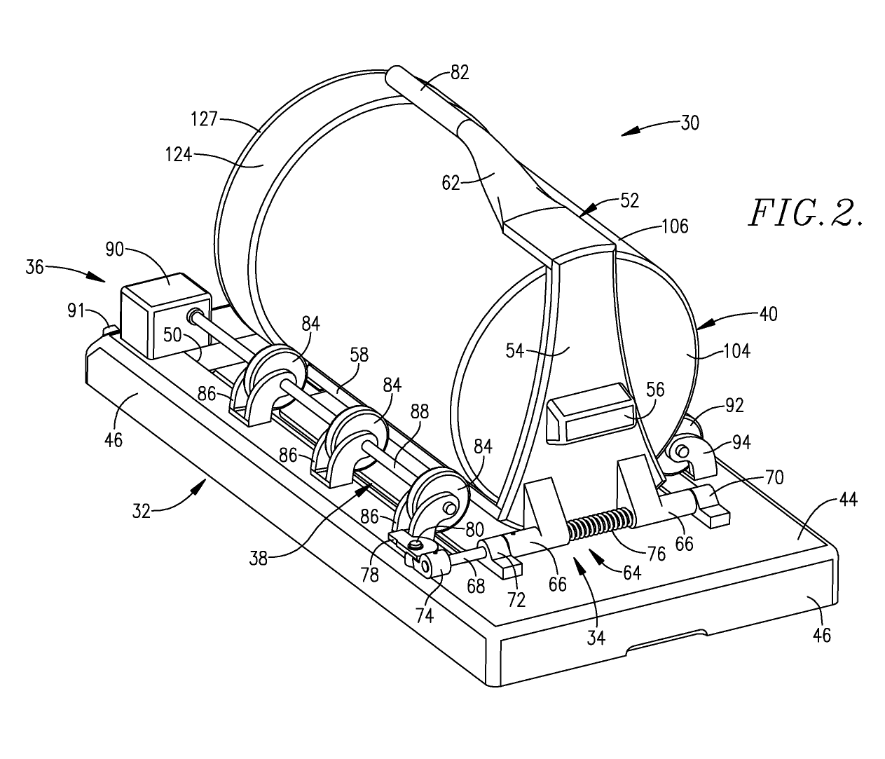

The container-receiving structure 34 is in the form of a cradle 52, which is pivotally mounted to upper wall 44. Specifically, the cradle 52 includes a lower platform 54 provided with a central projecting stop member 56, as well as a pair of elongated container-supporting arms 58 and 60 and an opposed handle 62 secured to platform 54. The platform 54 is mounted to base 32 by means of a pivot assembly 64. The assembly 64 includes a pair of laterally spaced apart, apertured brackets 66 secured to the underside of platform 54 and receiving a transverse pivot pin 68. The pin 68 is in turn received by bearings 70 and 72 and extends beyond the bearing 72, as shown (FIG. 2). The outboard end of pin 68 is equipped with a locking element 74. A helical lift assist torsion spring 76 is located between the brackets 66 and serves to urge the cradle 52 towards the upper position thereof, as will be described. A selectively operable cam lock 78 is pivotally mounted on upper wall 44 by means of pivot 80, and may be rotated into engagement with locking element 74 in order to maintain the cradle 52 in the lowered position thereof. The arms 58 and 60 are generally arcuate in cross-section in order to mate with the sidewall of container 40, whereas handle 62 includes an outwardly extending grip portion 82 allowing manual movement of the cradle 52 and container 40 between the lower and upper positions thereof. The cradle 52 is preferably configured such that in the lower cooking position the arms 58 and 60 and handle 62 are spaced from the outer surface of container 40 in order to allow free rotation of the latter. Also, the stop member 56 is oriented so that it engages upper wall 44 of base 32 when the cradle 52 and container 40 are in the upper position thereof, in order to provide better stability, the member 56 is dimensioned so that the container 40 is in a slightly (e.g., five degrees) over-center position towards the rear of base 32. The forward ballast structure 51 is of sufficient mass to compensate for such positioning of the cradle 52 and container 40.

The drive mechanism 36 includes three resilient elastomeric drive wheels 84 located in spaced apart relationship along the length of wall 44 and supported by respective bights 86 secured to upper wall 44. An elongated, axially rotatable drive shaft 88 passes through the individual bights 86 and is secured to the respective drive wheels 84. A selectively operable electrical drive motor 90 is attached to upper wall 44 and is drivingly connected with the adjacent end of shaft 88. The motor 90 has an electrical cord and plug (not shown) to provide electrical power, and is selectively operable via control button 91. In addition, three resilient elastomeric guide or idler wheels 92 are positioned in opposing relationship to the drive wheels 84, and are likewise mounted on bights 94. A shaft 96 is secured to each of the wheels 92 and passes through the bights 94, thereby permitting rotation of the wheels 92. It will be observed that the wheels 84 and 92 are located along the opposite lengths of the opening 50.

The heating device 38 is preferably a magnetic induction heater, including a housing 98 holding the work coil and associated electronics, a cooktop support surface 100, and an RFID reader with its associated RFID antenna 102. In conventional uses, a pot or other cookware is placed on cooktop 100 and is energized in order to create a time-changing magnetic field serving to heat the pot. In the context of this invention, however, the device 38 is situated within the base 32 and serves to heat container 40. The through-opening 50 of base 32 permits unimpeded passage of the magnetic field through the base.

In particularly preferred embodiments, the device 38 is of the type described in U. S. Pat. No. 6,953,919, as noted above. In particular, the device 38 is operable to control heating of food products by use of wireless communication between the device 38 and a temperature sensing assembly on a pot or other container. The temperature sensing assembly normally includes a temperature sensor operably coupled with the pot or container in order to directly or indirectly monitor the temperature of the food products on a continuous or intermittent basis throughout a normal operating range (e.g., −30° C. to 200° C.), with a coupled RFID tag. The device 38 periodically interrogates the temperature sensing assembly to obtain temperature data, and uses such data in a heating control algorithm to regulate the magnetic field produced by the device 38. Such a control system is referred to as a wireless RFID temperature feedback system.

The container 40 in this embodiment is of generally cylindrical configuration including a bottom wall 104 and a continuous circular sidewall 106. The container 40 may be formed of standard metallic materials, such as stainless steel, multiple-ply materials often including inner aluminum layers and outer stainless steel layers. Also, the container 40 may be constructed of carbon composite materials that may include flexible graphite sheeting wrapped about a carbon fiber reinforced plastic (CFRP) composite material shell. Such a design provides increased thermal conductivity and is relatively low in weight. For purposes of the present invention, the container 40 may be formed of any suitable induction heating-compatible material. Preferably, the inner surface of bottom wall 104 and sidewall 106 has anon-stick coating 108, such as Teflon or the like (see FIG. 18). In addition, the outer surface of sidewall 106 may be equipped with a graphite layer 110 and an outer high temperature polymer sealer layer 112. This construction assures that the graphite material is not subjected to moisture and maintains good thermal conductivity with the container wall.

In many instances, the container 40 will have an insulation layer between the inner food-contacting sidewall of the container, and ambient atmosphere. In this regard, the layer may be in the form of a removable, tubular, heat insulative shell cover 114 about the sealer layer 112, formed from any suitable material, such as polymeric foam, fiberglass matting, Aerogel insulation matting, silicate fibrous material, or any other suitable insulative material. Such a cover is maintained on the pot during heating or cooking steps, but is preferably removed during cool-down. Alternately, a permanent insulation layer may be provided between the sidewall of container 40 and an outer shell (not shown) constructed of non-heat-conducting material, such as nylon, propylene, or other material capable of withstanding continuous temperatures of up to approximately 250° F.

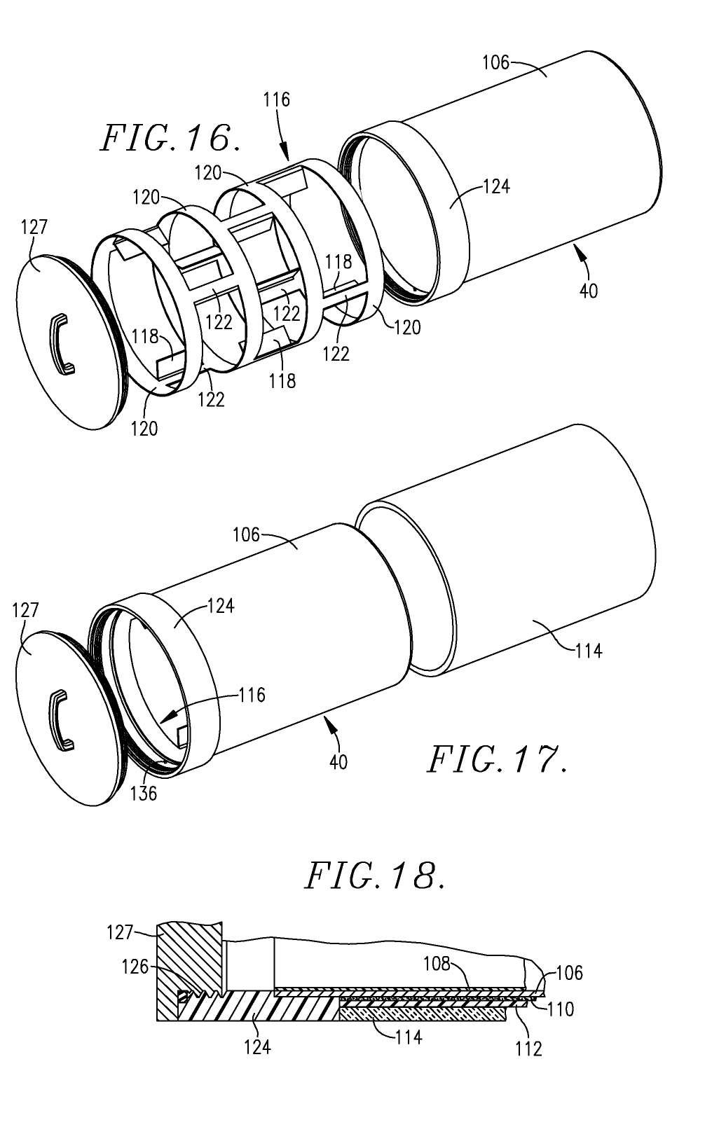

As best seen in FIGS. 7 and 16-17, the interior of container 40 maybe equipped with a fin assembly 116, which assists in mixing of ingredients within the container during rotation thereof. The fin assembly 116 may be of variable construction, so long as a plurality of inwardly extending fins 118 are provided. In the illustrated embodiment, the assembly 116 is of unitary construction and includes four spaced apart rings 120 interconnected by means of struts 122. The fins 118 extend from the struts 122, as shown. The assembly 116 is sized so as to mate with the internal surface of sidewall 106.

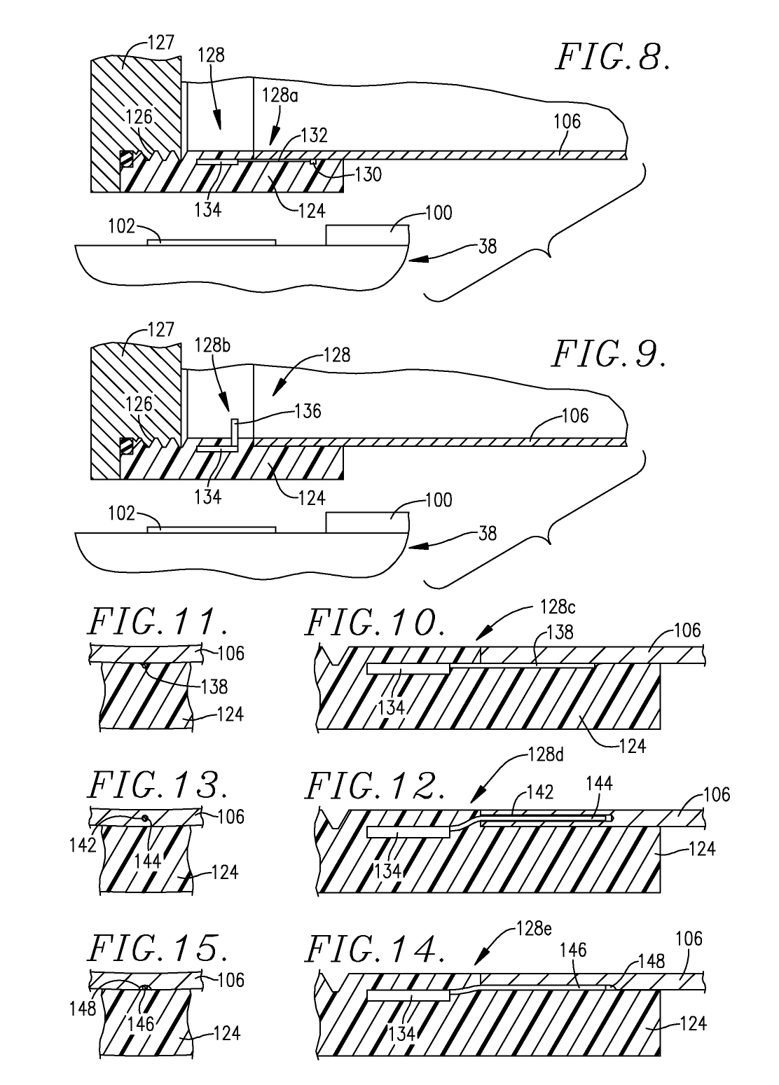

In order to provide heating control, a collar 124 is permanently secured to the open end of container 40 and extends for a distance beyond the butt open end of sidewall 106. The collar 124 may be made of suitable polymeric or ceramic materials, and is preferably rigid. The collar 124 may be designed for use only with sidewall 106 (see FIGS. 8-15), or may be designed to accommodate layers 110 and 112 and cover 114, if the latter components are employed. The inner surface of collar 124 spaced from the end of sidewall 106 is provided with threads 126. A complementally threaded solid lid 127 mates with collar 124 in order to provide a leakproof seal during heating of food product within container 40.

The collar 124 is used in conjunction with a plurality of sensor assemblies 128 made up of individual temperature sensors and associated RFID tags, the latter communicating with device 38 via antenna 102. Preferably, a plurality of sensor assemblies 128 are provided in circumferentially spaced relationship around collar 124, which successively communicate with device 38 as container 40 rotates.

A variety of different sensor assemblies 128 maybe used in this context, depending upon the heating conditions to be encountered and the type of product to be heated. Most of the various sensor assemblies 128 are used to measure the temperature of the container sidewall 160. For instance, referring to FIG. 8, each assembly 128a includes a temperature sensor 130 affixed to the outer surface of container sidewall 106, with a lead 132 extending to RFID tag 134 embedded with collar 124. Preferably, the temperature sensor 130 is a platinum-based resistant temperature device (RTD). The lead 132 allows sensed temperature information to be conveyed to RFID tag 134, so that such information may be wirelessly transmitted to device 38 as will be described.

FIGS. 10 through 14 illustrate a second type of sensor assembly 128 also used to measure the temperature of the container sidewall 160, but with three different connection methods to the sidewall. Each of the sensor assemblies 128 employs a temperature sensor and lead wire embedded within a stainless steel tube, hereafter referred to as a “sensor tube.” FIGS. 10 and 11 illustrate a sensor assembly 128c in the form of an elongated sensor tube 138 extending along the length of the outer surface of sidewall 106 and coupled with embedded RFID tag 134. Sensor assembly 128d (FIGS. 12 and 13) has a sensor tube 144 situated within an axial bore 142 provided in within sidewall 106, with sensor tube 144 operatively coupled with RFID tag 134. Finally, sensor assembly 128e is made up of an elongated sensor tube 146 located within an external slot 148 provided in the outer surface of sidewall 106, and again operatively coupled with RFID tag 134.

FIG. 9 illustrates a type of sensor assembly 128 whose purpose is to measure the temperature of the food within the container 140. Sensor assemblies 128b are each made up of a temperature sensor 136 extending inwardly of collar 124 and directly coupled to RFID tag 134. Thus, in this instance the sensor 136 is effectively within the confines of container 40, thus allowing direct food temperature information to be sensed and reported to the heating device 38. Preferably, at least one such assembly 128b is present among the plurality of sensor assemblies provided in circumferentially spaced relation around collar 124, as illustrated in FIG. 7. However, it will be appreciated that more or less of the assemblies 128b may be used.

FIG. 7 illustrates six circumferentially spaced sensor assemblies in place on the container 40. Five of these sensor assemblies shown measure the temperature of the container sidewall 160. These five sensor assemblies maybe any combination of sensor assemblies 128a, 128c, 128d, or 128e. One sensor assembly illustrated is labeled 128b. This sensor assembly has the temperature sensor 136 protruding through the container sidewall 160 so as to touch the food within container 40.

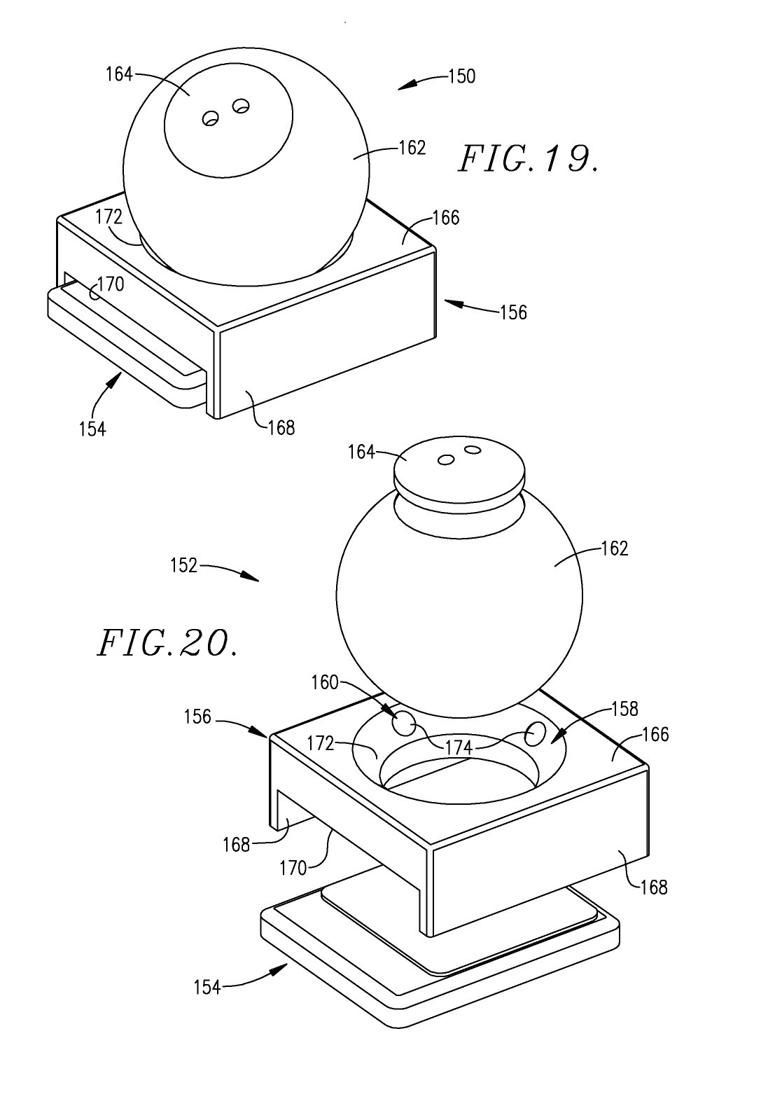

FIGS. 19 and 20 illustrate an alternate embodiment in the form of a system 150 broadly including a heating assembly 152 and magnetic induction heating device 154. The heating assembly 152 in turn includes a base 156 equipped with container-supporting structure 158 and drive assembly 160. A spherical container 162 is adapted to sit upon base 156 and has a removable lid 164.

The base 156 has an upper wall 166 and depending sidewalls 168 defining a recess 170 for removably receiving heating device 154. The container-supporting structure 158 includes a centrally apertured bowl 172 designed to mate with the spherical wall of container 162. Drive assembly 160 includes a plurality of circumferentially spaced apart rotable drive elements 174, which are selectively rotatable by means of a drive motor (not shown). A plurality of sensor assemblies (which may be any of the types of assemblies 128a-128e, described previously) are embedded within the spherical wall of container 162 and are operable to wirelessly communicate sensed temperature information to heating device 154.

### Operation

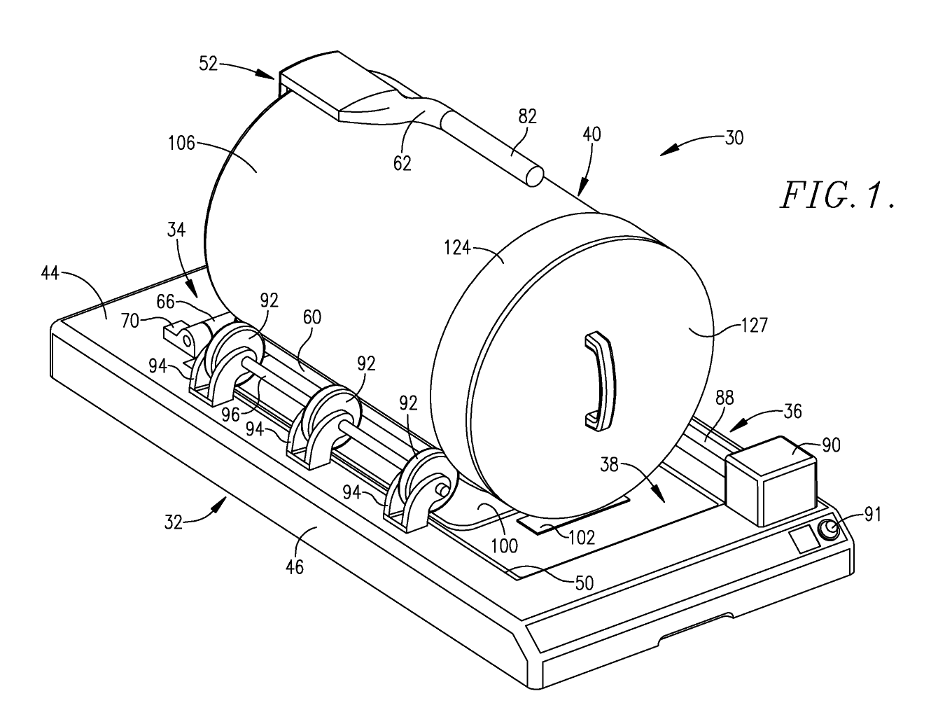

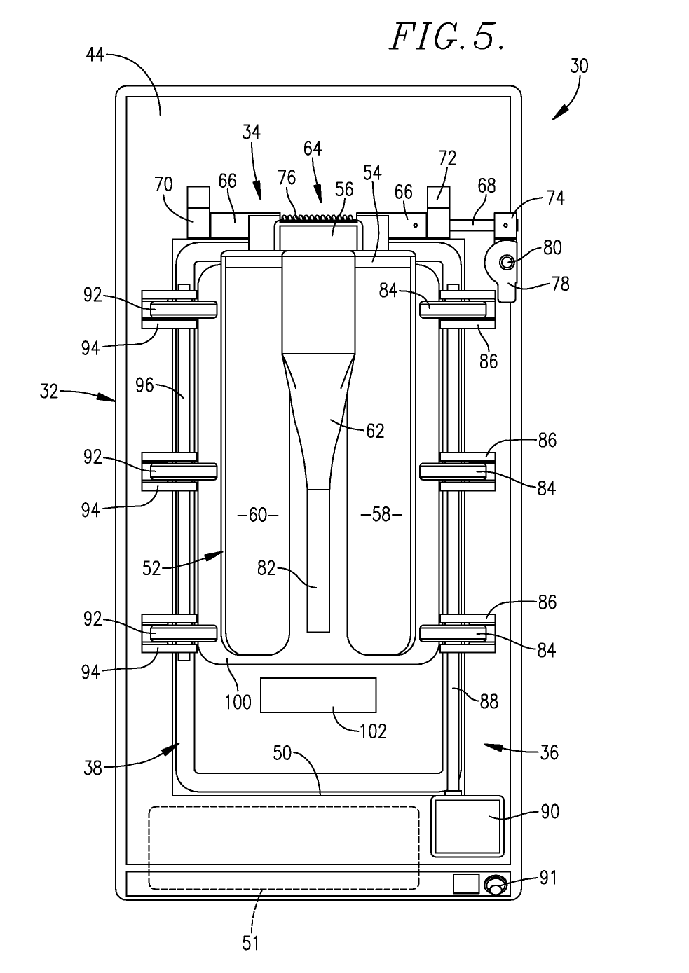

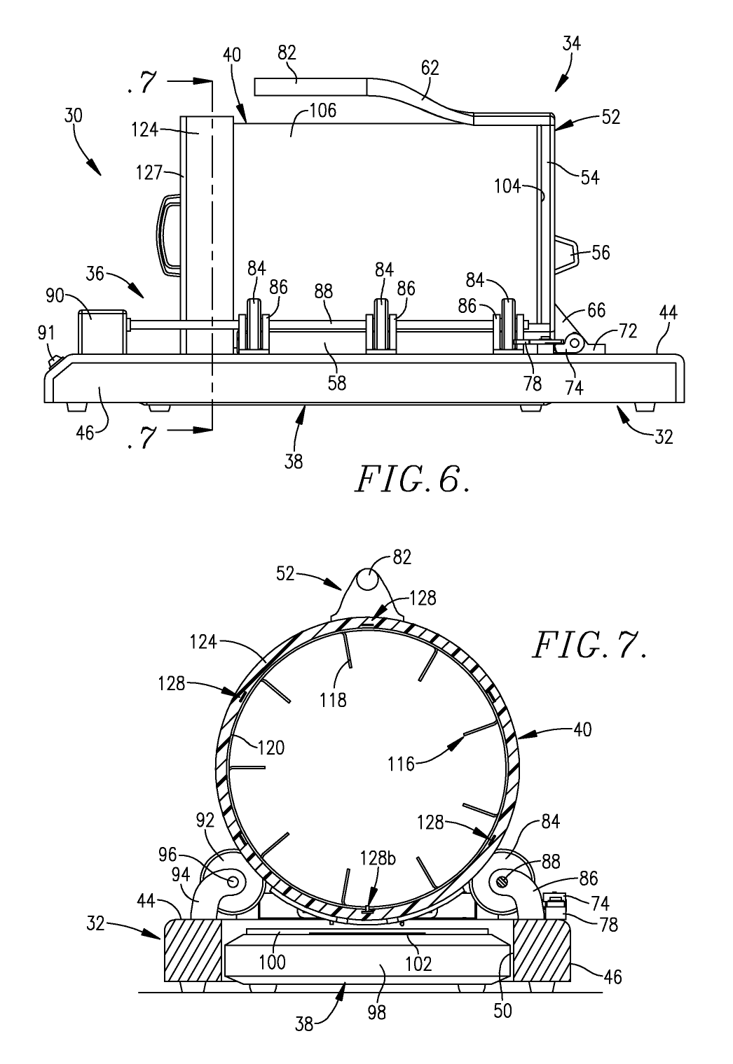

Referring to the embodiment of FIGS. 1-18, the operation of the system usually begins by placing base 32 over heating device 38 and moving cradle 52 to the upper loading and unloading position thereof. Container 40 absent lid 127 is then situated within the upright cradle 52. If food is not already present within container 40, the ingredients of the food product of interest may be loaded into the open end of container 40 and lid 127 is threadably secured to collar 124. The grip 82 is then used to rotate cradle 52 and loaded container 40 downwardly to the lowered cooking position, with container collar 124 and antenna 102 in close adjacency. In this lowered condition, the arms 58, 60 and handle 62 clear sidewall 106, and the latter is in full engagement with the drive wheels 84 and guide wheels 92. In order to secure the cradle 52 and container 40 in the lowered position, the cam lock 78 is rotated to engage element 74 to thus prevent rotation thereof. As can be appreciated, this prevents inadvertent upward movement of the cradle 52 and container 40.

At this point, the user can select an automatic cooking/warming recipe by either scanning a recipe card over the induction cooktop's RFID antenna (see U.S. Pat. No. 6,953,919), scanning a food package over the induction cooktop's RFID antenna, using the induction cooktop's interface to select a pre-programmed heating recipe, wirelessly communicating the recipe from a computer to the induction cooktop (if that unit has wireless compatibility), or other means. Furthermore, the rotational speed can either be set manually by the user (via the control knob 91) or could be automatically controlled by the induction cooktop's microprocessor via communications with the rotational mechanism.

As the cooking cycle begins, the induction heating device 38 generates appropriate magnetic field, and motor 90 operates so as to rotate drive wheels 84. The fins 118 within container 40 serve to continually lift and mix the food product to enhance even heating thereof.

In order to properly control the temperature of the product during the course of heating, the sensor assemblies 128 come into play. As container 40 rotates, the individual assemblies 128 consecutively rotate into communication range with RFID antenna 102 and thus with the device 38. Referring to FIG. 7, this communication range begins approximately when the sensor assembly 128 is directly above one edge of the RFID antenna 102 and ends when the sensor assembly 128 has rotated to a point directly above the opposite edge of the RFID antenna 102. Since the induction heater 38 only couples energy into a portion of the container where its sidewall 106 is within an inch or so of the induction heater's cooktop support surface 100, it is possible to choose a combination of antenna 102 widths (sizes) and circumferential sensor assembly spacings such that any time a portion of the container is being actively, inductively heated by the induction heater 38, it is receiving temperature feedback from at least one of the sensor assemblies.

Furthermore, the circumferential portion of the container 40 that starts when one sensor assembly 128 begins communicating temperature information via the RFID antenna 102 and ends when the same sensor assembly 128 has rotated to a point where it no longer can communicate via the RFID antenna 102, is an arc hereafter referred to as a “sensor assembly feedback zone.” It should be evident from FIG. 7 that, due to an RFID read range of at least 4 to 6 inches and a choice of sizes of RFID antenna 102, sensor assemblies spaced circumferentially 60 degrees apart can allow each sensor assembly to have a “sensor assembly feedback zone” whose leading edge (the portion of that zone that first rotates into the induction heater's magnetic field) begins communicating temperature with the induction heater 38 well in advance of said portion of the “sensor assembly feedback zone” being heated by the induction heater 38. This ability to read temperature of the container sidewall 106 prior to its being in the induction heater work coil's magnetic field allows the system to precisely adjust the applied magnetic field in advance of heating, so as to quickly and precisely achieve the desired temperature of the container side wall 106 and the food product itself throughout the entire rotation of the container 40. This advanced notice of required power application from the induction heater not only can prevent any damage to the food due to overly hot container wall surfaces, but it allows the fastest possible reheat of the food without damaging it.

As each “sensor assembly feedback zone” rotates through the heating zone of the induction heater 38 (where the heating zone exists directly above the induction heater's work coil), the feedback provided by the temperature information from the sensor assembly 128 allows the induction heater's microprocessor to make meaningful adjustments to its produced magnetic field that prevent overheating of the container side wall 106 while providing proper energy to the food within the container 40.

While a sensor assembly 128 exists within its sensor assembly feedback zone, wireless communication of temperature data (and other stored data on the sensor assembly whose examples are described in U.S. Pat. No. 6,953,919) occurs typically 16 times per second so that an average temperature can be used once per second to make adjustments to the magnetic field. During each rotation of container 40, the individual assemblies 128 respectively communicate via antenna 102 with the device 38. During such communications, the temperature conditions sensed by the temperature sensors are wirelessly transmitted to heating device 38. The microprocessor controller forming a part of the device 38 then appropriately modulates the magnitude of the induction heating radiation delivered by the heating device. In this fashion, the cooking cycle can be continued until the desired product temperature is reached. Moreover, this arrangement allows the use of a differential schedule of heating over different time periods, e.g., high intensity heating may be continued for periods of time with intermediate lower intensity heating periods.

When the food product within container 40 is heated and cooked to the desired extent, the device 138 is de-energized and motor 90 is stopped. In this condition, with cradle 52 and container 40 still locked in the lowered position thereof, the entire assembly 30 and loaded container 40 can be fully separated from device 38. Thus, the assembly 30 and container 40 can be placed in a cooler, for example, and the product may be rapidly cooled by again initiating operation of motor 90. If it is desired to subsequently reheat the product, the interconnected assembly 30 and container 40 are simply moved back to the initial cooking position over device 38, and a reheating cycle is initiated. When it is desired to remove food product (either hot or cold) from container 40, the cam lock 78 is rotated so as to clear the locking element 74, whereupon handle grip 82 is grasped and the cradle 52 with container 40 is moved upwardly to the loading/unloading position. This movement is assisted by the torsion spring 76. As noted previously, in the upper position the container 40 is slightly over-center, in order to insure against accidental tip over of the container.

The operation of the embodiment of FIGS. 19-20 is identical with that of the first embodiment, and the same results and advantages are achieved. This operation will be readily understood by a skilled artisan from the foregoing description as modified by the use of the spherical container 162 and associated support and drive elements.

We claim:

1. Apparatus operable to heat food product, said apparatus comprising:
a base presenting an upper surface and an underside, said base being permeable to a time-changing magnetic field;
structure on the upper surface of said base configured to receive a cooking container holding said food product, and to maintain the container in a heating orientation on the base; and
a drive mechanism operable to rotate said cooking container when the container is in said heating orientation,
said base being positionable in overlying relationship to an induction heating device in order to heat said food product during rotation of said container, said base and container being separable from said heating device at the conclusion of heating of said food product.

2. The apparatus of claim 1, said container-receiving structure comprising a cradle mounted on said base and configured to receive said cooking container, said cradle being shiftable between an upright food product loading and unloading position, and a lowered cooking position operably engaging said drive mechanism in order to rotate the container, and oriented to receive magnetic induction radiation.

3. The apparatus of claim 2, said cradle including a platform and a plurality of elongated, container-supporting arms secured to said platform, said arms shiftable to a position out of contact with said container when the container is in the lowered position thereof engaging said drive mechanism.

4. The apparatus of claim 3, said cradle further including a handle secured to said platform and remote from said arms, said handle being configured to be out of contact with said container when the container is in the lowered position thereof.

5. The apparatus of claim 4, said cradle including biasing structure urging said cradle and container to the upright position of the container.

6. The apparatus of claim 1, said container being of generally cylindrical configuration and presenting a bottom and a tubular sidewall extending from the bottom.

7. The apparatus of claim 1, said container including a lid releasably secured to said container.

8. The apparatus of claim 1, said container including internal fin structure on order to enhance mixing of said food product during rotation of the container.

9. The apparatus of claim 1, said container comprising an external heat insulating sleeve.

10. The apparatus of claim 1, said container having a plurality of spaced-apart temperature sensors operable to sense the temperature of said food product during rotation of the container, and data-transmitting structure operable to transmit said sensed temperature information, there being an antenna operably coupled with said induction heating device for receiving said transmitted temperature information.

11. The apparatus of claim 10, said data-transmitting structure comprising an RFID tag operably coupled with each of said temperature sensors.

12. The apparatus of claim 10, said sensors and said data-transmitting structure being mounted on a collar disposed about said container, said collar formed of synthetic resin material.

13. A system for heating food product, said system comprising:
an induction heating device operable to generate magnetic induction radiation;
a base situated over said device and being permeable to said magnetic induction radiation;
structure on the upper surface of said base configured to receive a cooking container holding said food product, and to maintain the container in a heating orientation on the base; and
a drive mechanism operable to rotate said cooking container when the container is in said heating orientation,
said heating device operable to heat said food product during rotation of said container, said base and container being separable from said heating device at the conclusion of heating of said food product.

14. The system of claim 13, said container-receiving structure comprising a cradle mounted on said base and configured to receive said cooking container, said cradle being shiftable between an upright food product loading and unloading position, and a lowered cooking position operably engaging said drive mechanism in order to rotate the container, and oriented to receive magnetic induction radiation.

15. The system of claim 14, said cradle including a platform and a plurality of elongated, container-supporting arms secured to said platform, said arms shiftable to a position out of contact with said container when the container is in the lowered position thereof engaging said drive mechanism.

16. The system of claim 15, said cradle further including a handle secured to said platform and remote from said arms, said handle being configured to be out of contact with said container when the container is in the lowered position thereof.

17. The system of claim 16, said cradle including biasing structure urging said cradle and container to the upright position of the container.

18. The system of claim 13, said container being of generally cylindrical configuration and presenting a bottom and a tubular sidewall extending from the bottom.

19. The system of claim 13, said container including a lid releasably secured to said container.

20. The system of claim 1, said container including internal fin structure on order to enhance mixing of said food product during rotation of the container.

21. The system of claim 13, said container comprising an external heat insulating sleeve.

22. The system of claim 13, said container having a plurality of spaced-apart temperature sensors operable to sense the temperature of said food product during rotation of the container, and data-transmitting structure operable to transmit said sensed temperature information, there being an antenna operably coupled with said induction heating device for receiving said transmitted temperature information.

23. The system of claim 22, said data-transmitting structure comprising an RFID tag operably coupled with each of said temperature sensors.

24. The system of claim 22, said sensors and said data-transmitting structure being mounted on a collar disposed about said container, said collar formed of synthetic resin material.

25. A method of heating food product using the system of claim 13, said method comprising the steps of:
introducing ingredients into said container, and locating the container on said container-receiving structure in a heating orientation;
operating said drive mechanism in order to rotate said container, and operating said heating device in order to generate magnetic induction radiation serving to heat said ingredients within the container; and
at the conclusion of heating of said ingredients, separating said base and container from said heating device.

26. The method of claim 25, including the step of moving the separated base and container to a cooler.

27. The method of claim 25, said container-receiving structure comprising a cradle mounted on said base and configured to receive said cooking container, said cradle being shiftable between an upright food product loading and unloading position, and a lowered cooking position operably engaging said drive mechanism in order to rotate the container, and oriented to receive magnetic induction radiation, said ingredient introduction step comprising the steps of moving said container to said upright food product loading position, introducing the ingredients into said container, and lowering the container to said cooking position.

28. A container adapted to hold food product to be heated, said container comprising:
a generally cylindrical container body adapted to hold said food product and presenting a bottom wall and a tubular sidewall extending from the bottom wall, said container body being axially rotatable during heating of said food product; and
a plurality of temperature sensing assemblies operably secured to said tubular sidewall in circumferentially spaced apart relationship, each of said assemblies including a temperature sensor positioned to sense the temperature of said food product during heating thereof, and temperature data-transmitting structure operably coupled with said sensor in order to wirelessly transmit sensed temperature information to a heating device,
each of said data-transmitting structures operable to successively transmit updated temperature information related to the temperature of said food product during said rotation of the container body.

29. The container of claim 28, said data-transmitting structure comprising an individual RFID tag operably coupled to each of said temperature sensors.

30. The container of claim 28, including a circular synthetic resin collar disposed about said sidewall, said collar housing said data-transmitting structure, said temperature sensors operably coupled with said structure.

31. The container of claim 28, said temperature sensors operably engaging said sidewall.

32. The container of claim 28, said temperature sensors extending inwardly relative to the inner surface of said sidewall.
